(19) United States
(12) Patent Application Publication
(10) Pub. No.: US 2026/0265150 A1
(43) Pub. Date: Sep. 10, 2026

(54) ULTRA-HIGH-TEMPERATURE CERAMIC (UHTC)-CONTAINING COATINGS AND METHODS OF DEPOSITING THE SAME

(71) Applicants: Arvind Agarwal, Miami, FL (US); Ambreen Nisar, Miami, FL (US); Anil Lama, Miami, FL (US); Denny John, Miami, FL (US)

(72) Inventors: Arvind Agarwal, Miami, FL (US); Ambreen Nisar, Miami, FL (US); Anil Lama, Miami, FL (US); Denny John, Miami, FL (US)

(73) Assignee: The Florida International University Board of Trustees, Miami, FL (US)

(21) Appl. No.: 19/071,289

(22) Filed: Mar. 5, 2025

(51) Int. Cl. C04B 35/56; C23C 24/04

(52) U.S. Cl. CPC C04B 35/5622; C04B 35/5607; C23C 24/04; C04B 2235/3839; C04B 2235/5288; C04B 2235/5436

(57) ABSTRACT

Ultra-high-temperature ceramic (UHTC) compositions (including coatings and nanocomposites) and methods of depositing the same on a substrate are provided. A low-pressure cold spray system can be used to deposit a powder having a critical powder size distribution (PSD). The substrate surface can have a surface roughness to promote anchoring of the UHTC particles.

### GOVERNMENT SUPPORT

This invention was made with government support under W911NF-20-2-0256 awarded by the Army Research Laboratory-Army Research Office. The government has certain rights in the invention.

### BACKGROUND

Ultra-high-temperature ceramics (UHTCs) are ideal for extreme aerospace applications due to their exceptional properties, including a melting point above 3000° C., high hardness, thermal conductivity, elastic modulus, and wear resistance. However, their high melting temperature makes traditional manufacturing techniques challenging.

### BRIEF SUMMARY

Embodiments of the subject invention provide novel and advantageous ultra-high-temperature ceramic (UHTC) compositions (including coatings and nanocomposites) and methods of depositing the same (e.g., depositing on a substrate, such as a metal substrate). A low-pressure cold spray system can be used to deposit a powder having a critical powder size distribution (PSD). The substrate surface can have a surface roughness, such as a roughness of at least 1 micrometer (μm) (e.g., at least 1.5 μm, at least 1.8 μm, or about 1.8 μm) to promote anchoring of the UHTC particles. The PSD can be, for example, 10 μm or less, such as 5 μm or less (e.g., in a range of from 100 nanometers (nm) to 10 μm, such as from 100 nm to 5 μm).

In an embodiment, a method for depositing a coating (that comprises a UHTC) can comprise: preparing a powder comprising the UHTC, the powder having a PSD of 10 μm or less (e.g., 5 μm or less); and performing a cold spray deposition, using the powder as a feed material, to deposit the coating on a first surface of a substrate, the first surface of the substrate having a surface roughness of, for example, at least 1 μm (e.g., at least 1.7 μm, at least 1.8 μm, or at least about 1.8 μm). The cold spray deposition can be performed at a temperature of, for example, no more than 1,200° C., such as no more than 1,000° C., no more than 900° C., no more than 800° C., no more than 700° C., no more than 600° C., or no more than 550° C. (e.g., in a range of from 400° C. to 600° C., such as 500° C. or about 500° C.). A thickness of the coating can be in a range of, for example from 100 nanometers (nm) to 100 μm (e.g., from 1 μm to 100 μm, from 1 μm to 10 μm, from 1 μm to 5 μm, or from about 2 μm to 5 μm). The substrate can comprise, for example, a metal, a ceramic, and/or a polymer. The method can further comprise, before performing the cold spray deposition, mixing the UHTC with nanomaterials, such that the powder used as the feed material for the cold spray deposition comprises agglomerates (e.g., spherical agglomerates and/or substantially spherical agglomerates) of the UHTC and the nanomaterials. The nanomaterials can comprise, for example, nanotubes, such as carbon nanotubes (CNTs) and/or boron nitride nanotubes (BNNTs). The UHTC can be, for example, tantalum carbide (TaC) or hafnium carbide (HfC). The preparing of the powder can comprise milling (e.g., ball milling or cryomilling) the UHTC to obtain the PSD. The preparing of the powder can further comprise performing spray drying after the milling. The milling can be done before or after the optional mixing with nanomaterials, and the spray drying can be done after the optional mixing with nanomaterials. The cold spray deposition can be performed while a distance between the first surface of the substrate and a nozzle of a cold spray deposition system performing the cold spray deposition is in a range of, for example, from 1 millimeter (mm) to 10 mm (e.g., 5 mm or about 5 mm). The cold spray deposition can be performed at a pressure of, for example, no more than 300 pounds per square inch (psi) (e.g., 100 psi, about 100 psi, or in a range of from 50 psi to 300 psi).

In another embodiment, a composition can comprise: a substrate having a first surface; and a coating disposed on the first surface of the substrate and comprising a UHTC. The composition can be formed using the method discussed in the previous paragraph (including any or all of the features discussed therein). The first surface of the substrate can have a surface roughness of, for example, at least 1 μm (e.g., at least 1.7 μm, at least 1.8 μm, or at least about 1.8 μm). A thickness of the coating can be in a range of, for example from 100 nm to 100 μm (e.g., from 1 μm to 100 μm, from 1 μm to 10 μm, from 1 μm to 5 μm, or from about 2 μm to 5 μm). The coating can further comprise nanomaterials (mixed with the UHTC). The nanomaterials can comprise, for example, nanotubes (e.g., CNTs and/or BNNTs. The UHTC can be, for example, TaC or HfC. The substrate can comprise, for example, a metal, a ceramic, and/or a polymer.

### BRIEF DESCRIPTION OF DRAWINGS

FIG. 1a shows a microscope image of tantalum carbide (TaC) powder with an average particle size of 0.36 micrometers (μm)+/−0.016 μm. The scale bar is 1 μm.

FIG. 1b shows a microscope image of a hafnium carbide (HfC) powder with an average particle size of 0.33 μm+/−0.075 μm. The scale bar is 1 μm.

FIG. 1c shows a microscope image of a spray dried powder of TaC with 4 weight percentage (wt. %) of carbon nanotubes (CNT) powder, with the CNTs being uniformly distributed. The scale bar is 10 μm.

FIG. 1d shows a microscope image with an enlarged view of the box from FIG. 1c. The scale bar is 0.5 μm.

FIG. 2 shows a schematic view of a cold spray process for ultra-high-temperature ceramic (UHTC) powders, according to an embodiment of the subject invention. FIG. 2 shows the stages of powder engineering, cold spray deposition, and the evolution of bonding.

FIG. 3a shows an image of a TaC coating coated on an aluminum (Al) 6061 substrate.

FIG. 3b shows a microscope image of the top surface of the TaC coating from FIG. 3a, showing coating deposition. The scale bar is 5 μm.

FIG. 3c shows a microscope image of a cross section of the TaC coated substrate from FIG. 3a, showing a uniformly distributed coating with a thickness of about 5 μm. The scale bar is 10 μm.

FIG. 3d shows a microscope image with an enlarged view of the box from FIG. 3b. The scale bar is 0.5 μm.

FIG. 3e shows a microscope image with an enlarged view of the box from FIG. 3c. The scale bar is 1 μm.

FIG. 4a shows an image of a HfC coating coated on an Al 6061 substrate.

FIG. 4b shows a microscope image of the top surface of the HfC coating from FIG. 4a, showing coating deposition. The scale bar is 10 μm.

FIG. 4c shows a microscope image of a cross section of the HfC coated substrate from FIG. 4a, showing a uniformly distributed coating with a thickness of about 5 μm. The scale bar is 5 μm.

FIG. 4d shows a microscope image with an enlarged view of the box from FIG. 4b. The scale bar is 0.5 μm.

FIG. 4e shows a microscope image with an enlarged view of the box from FIG. 4c. The scale bar is 0.5 μm.

FIG. 5a shows an image of a coating of TaC with 4 wt. % CNT (TaC-4 CNT) coated on an Al 6061 substrate.

FIG. 5b shows a microscope image of the top surface of the TaC-4 CNT coating from FIG. 5a, showing coating deposition. The scale bar is 1 μm.

FIG. 5c shows a microscope image of a cross section of the TaC-4 CNT coated substrate from FIG. 5a, showing a uniformly distributed coating with a thickness of about 5 μm. The scale bar is 10 μm.

FIG. 5d shows a microscope image with an enlarged view of the box from FIG. 5b. The scale bar is 100 nanometers (nm).

FIG. 5e shows a microscope image with an enlarged view of the box from FIG. 5c. The scale bar is 0.5 μm.

FIG. 6a shows an energy dispersive spectroscopy (EDS) scan of a cross section of a HfC coating. The scale bar is 1 μm.

FIG. 6b shows an EDS scan of a cross section of a TaC coating. The scale bar is 1 μm.

FIG. 6c shows a table with results of the EDS scan from FIG. 6a for the HfC coating.

FIG. 6d shows a table with results of the EDS scan from FIG. 6b for the TaC coating.

FIG. 7a shows a plot of intensity (in arbitrary units (a.u.)) versus 2 theta (in degrees), showing the X-ray diffraction (XRD) response of a TaC coating on an Al substrate (the curve with the higher intensity values across the 2 theta values). The results for TaC powder are also shown (the curve with the lower intensity values across the 2 theta values). The peaks labeled with a circle with a line through it are for TaC, and the peaks labeled with a star are for Al.

FIG. 7b shows a plot of intensity (in a.u.) versus 2 theta (in degrees), showing the XRD response of a HfC coating on an Al substrate (the curve with the higher intensity values across the 2 theta values). The results for HfC powder are also shown (the curve with the lower intensity values across the 2 theta values). The peaks labeled with a circle with a line through it are for HfC, and the peaks labeled with a star are for Al.

FIG. 8a shows a microscope image of an HfC coating. The scale bar is 1 μm.

FIG. 8b shows atomic force microscopy (AFM) results for the region of the HfC coating labeled with the box in FIG. 8a. FIG. 8b shows the three-dimensional (3D) Z height.

FIG. 8c shows a table with nanoscale mechanical response values for the HfC coating shown in FIG. 8a. The table includes the average nanohardness (in Vickers Hardness scale (HV)) and the elastic modulus (in gigapascals (GPa)) for the HfC coating.

FIG. 9a shows a microscope image of a fractured cross-section of a coating of TaC with CNTs. FIG. 9a highlights the formation of slip lines due to particle impact and localized bonding. The scale bar is 100 nm.

FIG. 9b shows a microscope image of a polished cross-section of a coating of TaC with CNTs. FIG. 9b illustrates the pinning of TaC particles onto the substrate and the subsequent buildup of the coating through mechanical interlocking. The scale bar is 0.5 μm.

FIG. 9c shows a microscope image of a fractured cross-section of a coating of TaC with CNTs. FIG. 9c provides detailed insight into the deformation mechanisms at play. The scale bar is 100 nm.

FIGS. 10a and 10b show a table of properties of UHTCs and their composites (and methods of making the same) according to embodiments of the subject invention and those of related art works. FIG. 10a shows the first part of the table, and FIG. 10b shows the second part of the table. The first row in FIG. 10a shows results for embodiments of the subject invention (labeled “This work”). The column labeled “PATENT” is for patents and published applications of the related art, as well as “This work”. The related art works included in the table of FIGS. 10a and 10b are: U.S. Patent Application Publication No. 2023/0366098 (second row in FIG. 10a), U.S. Patent Application Publication No. 2021/0135083, U.S. Patent Application Publication No. 2020/0303614, U.S. Patent Application Publication No. 2019/0355891, U.S. Pat. Nos. 11,617,291, 10,957,840, and 10,714,671 (first row in FIG. 10b); and U.S. Patent Application Publication No. 2022/0049360 and U.S. Pat. No. 11,473,200 (second row of FIG. 10b). All five published U.S. patent applications and all four U.S. patents listed in FIGS. 10a and 10b are hereby incorporated by reference herein in their entireties.

### DETAILED DESCRIPTION

Embodiments of the subject invention provide novel and advantageous ultra-high-temperature ceramic (UHTC) compositions (including coatings and nanocomposites) and methods of depositing the same (e.g., depositing on a substrate, such as a metal substrate). A low-pressure cold spray system can be used to deposit a powder having a critical powder size distribution (PSD). The substrate surface can have a surface roughness, such as a roughness of at least 1 micrometer (μm) (e.g., at least 1.5 μm, at least 1.8 μm, or about 1.8 μm) to promote anchoring of the UHTC particles. The PSD can be, for example, 10 μm or less, such as 5 μm or less (e.g., in a range of from 100 nanometers (nm) to 10 μm, such as from 100 nm to 5 μm).

UHTCs, with melting temperatures exceeding 3,000° C. possess a unique combination of metal-like and ceramic-like properties, rendering them suitable for high-temperature applications (e.g., greater than 2,500° C.). However, their high melting temperature poses significant challenges to traditional manufacturing techniques. Conventional ceramic coating manufacturing methods, including physical vapor deposition (PVD) and chemical vapor deposition (CVD), require ultrahigh vacuum conditions. Thermal spray methods, such as flame spray, plasma spray, and high-velocity oxy-fuel spray, suffer from porosity, semi-molten particles, and unwanted phase transformations.

Cold spray deposition, which utilizes kinetic energy to deposit particles, offers an advantageous alternative to conventional ceramic coating manufacturing methods due to its low thermal energy. Though, cold spray is typically limited to malleable materials like metals. Embodiments of the subject invention can extend cold spray to brittle ceramics by engineering the plasticity of ceramics by attaining a critical PSD, applied strain rate, and temperature. This can be achieved by engineering a critical PSD, spray drying the powder, preparing the substrate surface, and/or preparation of the coating.

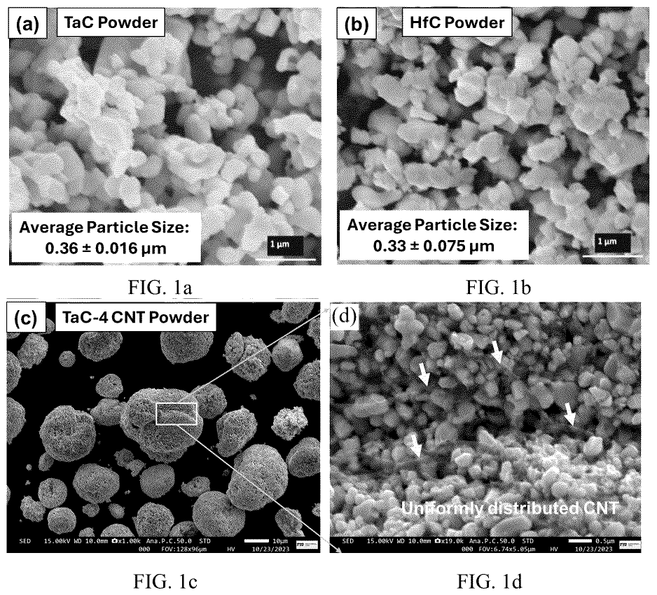

With respect to engineering a critical PSD, the PSD can be controlled to be in a predetermined range (e.g., 100 nm to 5 μm) to activate sufficient plasticity during high-strain deposition. UHTC powders can be procured in this range or engineered using ball milling or cryomilling (see also FIGS. 1a and 1b).

With respect to spray drying of the powder, the UHTC powder can be mixed with nanomaterials (e.g., carbon nanotubes (CNTs) and/or boron nitride nanotubes (BNNTs) and formed into spherical-shaped agglomerates, ensuring uniform distribution of the nanomaterials (e.g., CNTs and/or BNNTs). The agglomerates can break into pieces during the impact in the cold spray process (see also FIGS. 1c and 1d).

With respect to substrate surface preparation, the substrate surface (e.g., a metal such as aluminum (Al) (e.g., Al 6061-T6)) can be prepared to have sufficient roughness (e.g., at least 1 μm, such as at least 1.8 μm or about 1.8 μm) to promote anchoring of the UHTC particles. This roughness can be achieved by, for example, polishing the substrate with gritty paper (e.g., silicon carbide (SiC) paper, such as 80-grit SiC paper) and/or grit blasting.

With respect to coating preparation, a cold spray system (e.g., a low-pressure cold spray system) can be used for depositing UHTC coatings and/or UHTC-nanomaterial coatings (e.g., UHTC-CNT coatings and/or UHTC-BNNT coatings) on a substrate (e.g., a metal substrate such as an Al substrate). The deposition can be done at a pressure in a range of, for example, from 50 pounds per square inch (psi) to 300 psi (e.g., 100 psi or about 100 psi). The deposition can be done at a temperature in a range of, for example, from 100° C. to 800° C. (e.g., in a range of from 400° C. to 600° C., such as 500° C. or about 500° C.). The deposition can be done with a standoff (distance from spray nozzle to substrate) in a range of, for example, from 1 millimeter (mm) to 30 mm (e.g., 5 mm or about 5 mm). The carrier gas can be, for example, nitrogen, though embodiments are not limited thereto.

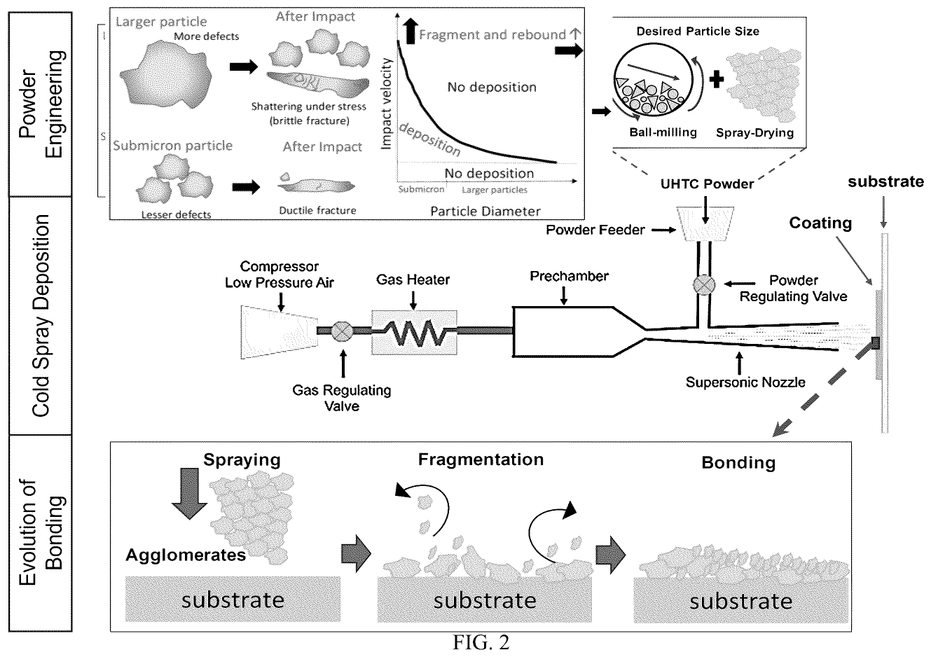

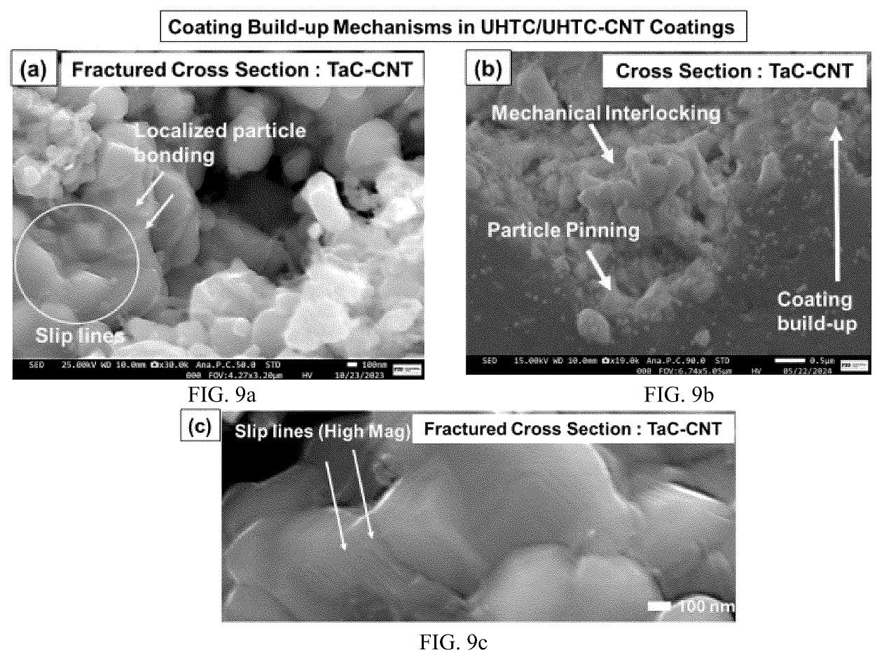

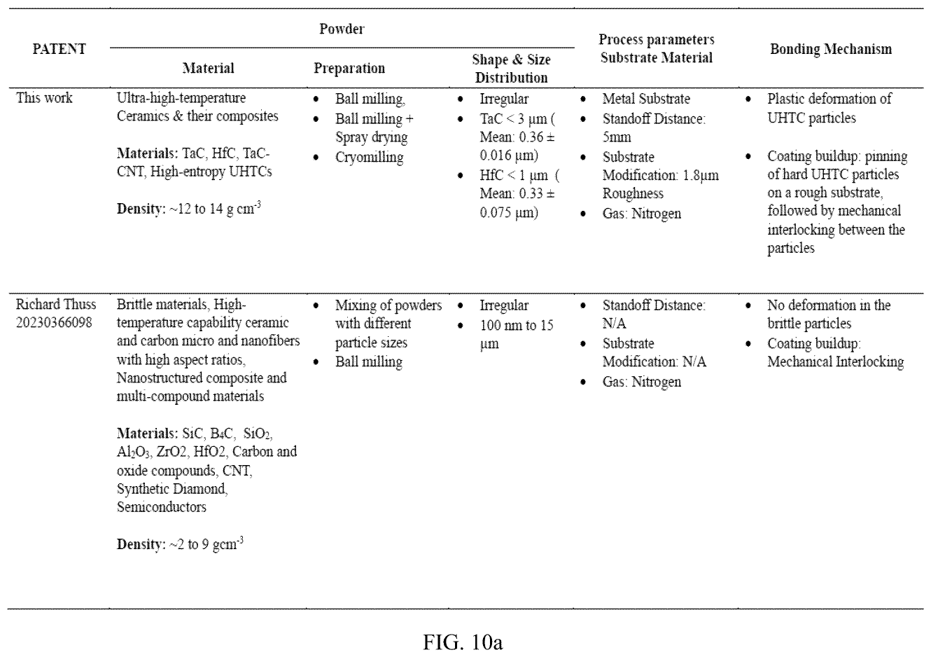

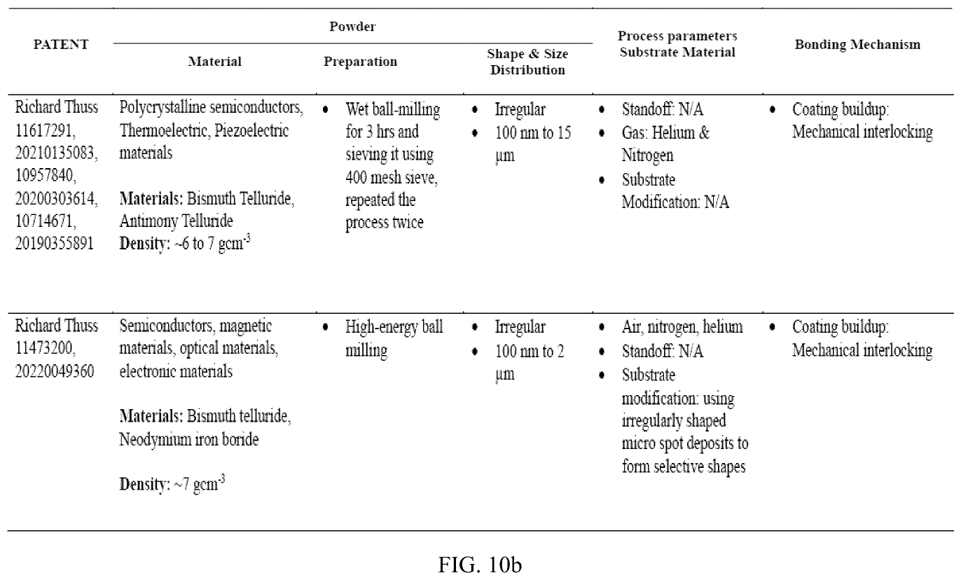

FIG. 2 shows a schematic illustration of the cold spray process of UHTC and UHTC-containing powders, according to an embodiment of the subject invention. During cold spray deposition, the irregularly shaped submicron UHTC particles can impact the rough substrate surface. These particles can become anchored and pinned to the surface irregularities, followed by mechanical interlocking (see also FIGS. 9a-9c). The critical PSD and nanoscale-induced plasticity facilitate localized deformation, as depicted in FIGS. 9a-9c. This combination of pinning, mechanical interlocking, and localized plasticity enables the layer-by-layer deposition and buildup of UHTC and UHTC-containing coatings.

Embodiments of the subject invention allow for the deposition of thin (e.g., less than 100 μm) UHTC and UHTC-containing (e.g., UHTC-CNT and/or UHTC-BNNT) coatings, significantly enhancing the oxidation resistance and extending the service life of components made from heat-resistant alloys. Additionally, embodiments of the subject invention provide a solution for repairing structural components exposed to extreme temperatures.

The UHTC and UHTC-containing coatings of embodiments of the subject invention can have a thickness in a range of, for example, from 100 nm to 100 μm (e.g., in a range from 100 nm to 10 μm, such as from 1 μm to 6 μm). In an embodiment, UHTC and UHTC-containing coatings of embodiments of the subject invention can have a thickness of 5 μm or about 5 μm.

Embodiments of the subject invention allow for deposition of coatings containing high-density (e.g., at least 12 grams per cubic centimeter (g/cm³)) UHTCs and/or their nanocomposites. This can include at least two important steps. First, critical PSD (submicron size) can be engineered in UHTC powders to activate the localized plasticity thereof, and the powder can then optionally be spray-dried with nanomaterials (e.g., CNTs and/or BNNTs). Second, high-strain solid-state deposition can be performed, in which the powders are deposited using a high-strain solid-state cold spray process, enabling the formation of UHTC and UHTC nanocomposite coatings.

During cold spray deposition, the irregularly shaped submicron UHTC particles can impact the rough substrate surface. These particles can become anchored and pinned to the surface irregularities, followed by mechanical interlocking. The critical powder size distribution and nanoscale-induced localized plasticity facilitate localized deformation. This combination of pinning, mechanical interlocking, and localized plasticity enables the layer-by-layer deposition and buildup of UHTC coatings. These coatings offer excellent thermal and wear protection for structural components, making them suitable for applications such as rocket propulsion components, leading edges, control surfaces, and nose cones for hypersonic flight and atmospheric re-entry craft. Additionally, they can be used to repair ceramic structures. This technology can be extended to at least the following: UHTC carbides, borides, and nitrides; high entropy (HE) combinations of these UHTCs; and their composites engineered with nanomaterials such as CNTs and BNNTs.

Embodiments of the subject invention provide thin, high-density (e.g., greater than 12 g/cm³) UHTC coatings and their nanocomposites on substrates (e.g., substrates). The deposited UHTC can be, for example, tantalum carbide (TaC, density of 14.3 g/cm³), hafnium carbide (HfC, density of 12.2 g/cm³), TaC or HfC reinforced with nanomaterial (e.g., CNTs and/or BNNTs), or a combination thereof. Powder engineering is important in achieving a critical PSD (e.g., less than 5 μm), followed by (optional) uniform dispersion of a nanomaterial (e.g., CNTs and/or BNNTs) through a spray drying process. The engineered powder can then be deposited using a cold spray system (e.g., a low-pressure cold spray system), which can be equipped with a control (e.g., a precision control robot). This results in a uniform (or substantially uniform) coating thickness (e.g., in a range of from 2 μm to 5 μm) with negligible heat-affected zone. The coating buildup is facilitated by a combination of pinning, mechanical interlocking, and localized plasticity of UHTC particles on the substrate and prior deposited particles. These coatings can be applied to a wide range of metallic, ceramic, and polymer substrates, including conventionally manufactured and additively manufactured structures, providing high-temperature protection (e.g., greater than 2,500° C.) and wear resistance, along with repair capabilities.

Related art methods for manufacturing UHTC or UHTC-containing coatings, such as PVD, CVD, and thermal spray methods, have several significant limitations. These methods often require high-temperature sintering, ultrahigh vacuum conditions, or high temperatures, leading to challenges such as porosity, semi-molten particles, and phase transformation. Further, due to the complexity of the experimental setup, these techniques are unsuitable for on-site structural repairs and restoration of existing structures. In contrast, embodiments of the subject invention leverage the advantages of cold spray technology, which utilizes low thermal energy (e.g., temperature of about 500° C. (or less)) to deposit UHTC coatings. This highly portable technique enables the repair and restoration of structures on site. This approach also ensures minimal heat-affected zones, the absence of high-temperature phase transformation, and no melting or re-solidification issues, thereby overcoming the drawbacks of related methods. embodiments of the subject invention enable the deposition of ceramic coatings with improved properties, which are ideal for many applications, including but not necessarily limited to rocket propulsion components, leading edges, control surfaces, nose cones for hypersonic flight and atmospheric re-entry craft, and repairing of ceramic structures.

Compared to the related art, advantages of embodiments of the subject invention include at least the following: no requirement for high processing temperatures; compatible with compact and simple machinery that is highly portable to do shop floor production as well as on-site repairs; uniform coating deposition (e.g., in a range of from 2 μm to 5 μm, or from about 2 μm to about 5 μm); and the absence of any oxide phases and/or thermal transformations in the coating.

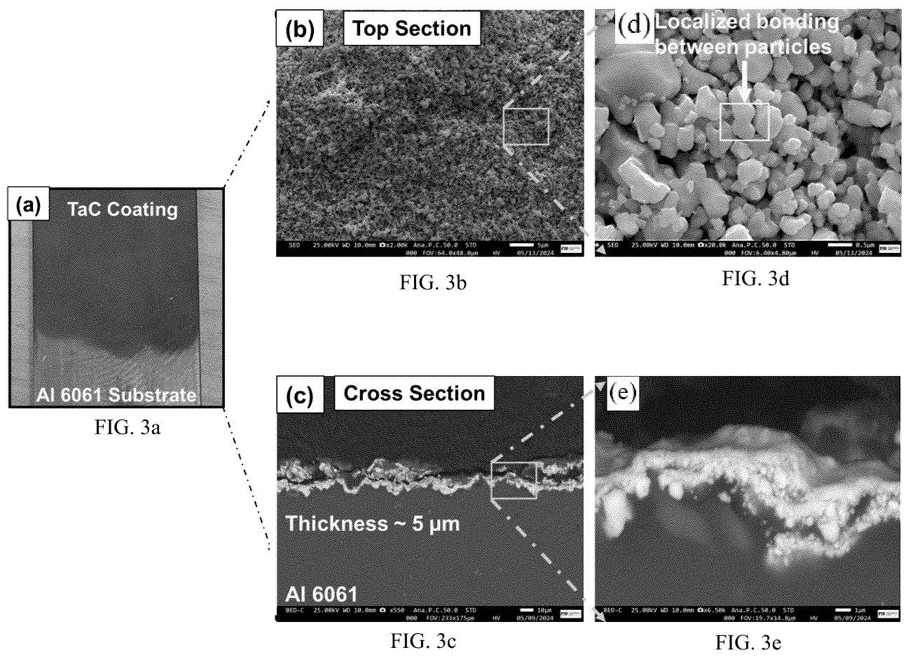

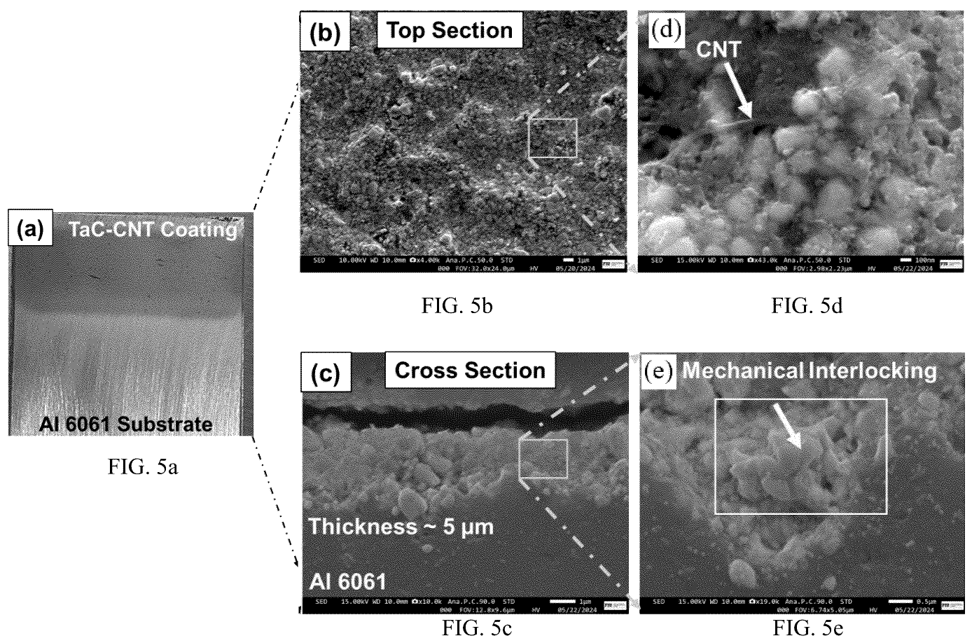

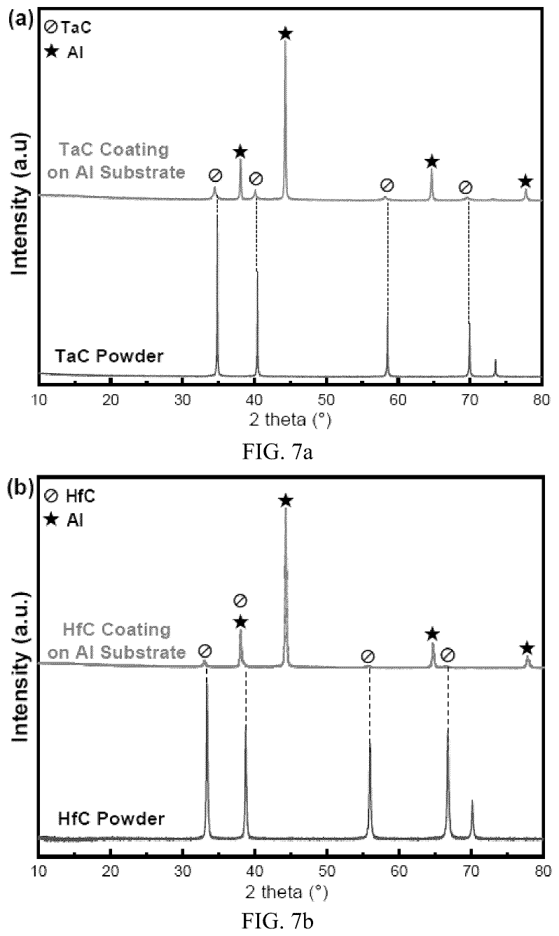

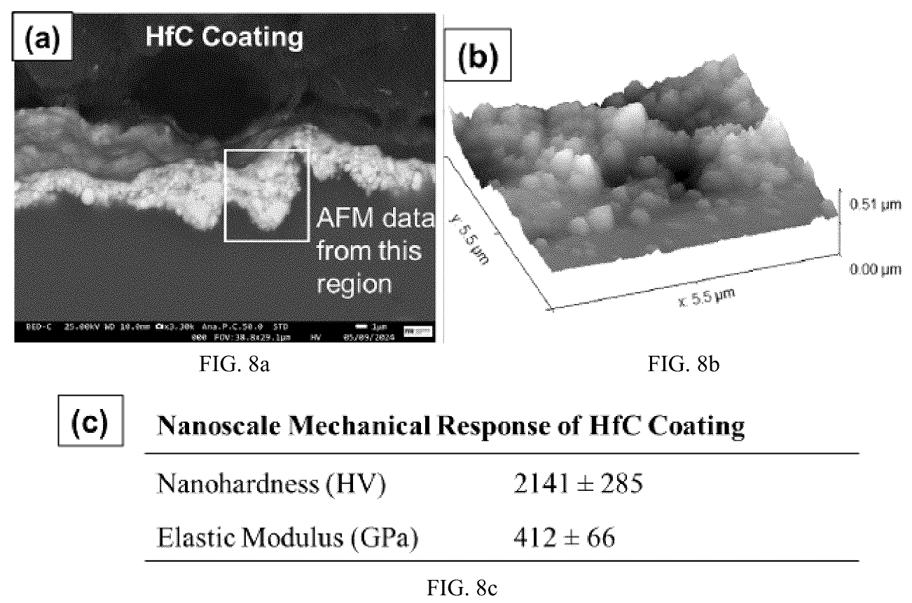

Embodiments of the subject invention provide cold-sprayed high-density UHTC and UHTC-containing (e.g., UHTC-CNT and UHTC-BNNT) coatings on substrates (see also FIGS. 3a-3d, 4a-4d, and 5a-5d). No phase transformation and oxidation occurs in the UHTC coating region due to the fact that processing temperatures are significantly lower than the melting temperature of the UHTC material (i.e., processing temperatures much less than 3,000° C.) (see also FIGS. 7a and 7b). Large and scalable UHTC/UHTC-nanomaterial coatings can be produced, and embodiments can be used for large-scale repair of ceramic structures (see also FIGS. 3a-3d, 4a-4d, and 5a-5d). Embodiments of the subject invention also provide: precision controllable automated layer-by-layer deposition of UHTC and UHTC-containing coatings; uniform coating with a thin thickness (e.g., in a range of from about 2 μm to 5 μm), which can be increased or decreased (as desired) by further optimization (see also FIGS. 3a-3d, 4a-4d, and 5a-5d); preservation of nanomaterials (e.g., CNTs) without any structural and/or thermal degradation (see also FIGS. 5a-5d); and ultra-hard UHTC coatings (e.g., Vickers Hardness of at least 1,000, such as at least 1,800, at least 2,000, or at least 2,100) (see also FIGS. 8a-8c).

When ranges are used herein, combinations and subcombinations of ranges (including any value or subrange contained therein) are intended to be explicitly included. When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

A greater understanding of the embodiments of the subject invention and of their many advantages may be had from the following examples, given by way of illustration. The following examples are illustrative of some of the methods, applications, embodiments, and variants of the present invention. They are, of course, not to be considered as limiting the invention. Numerous changes and modifications can be made with respect to embodiments of the invention.

### Example 1

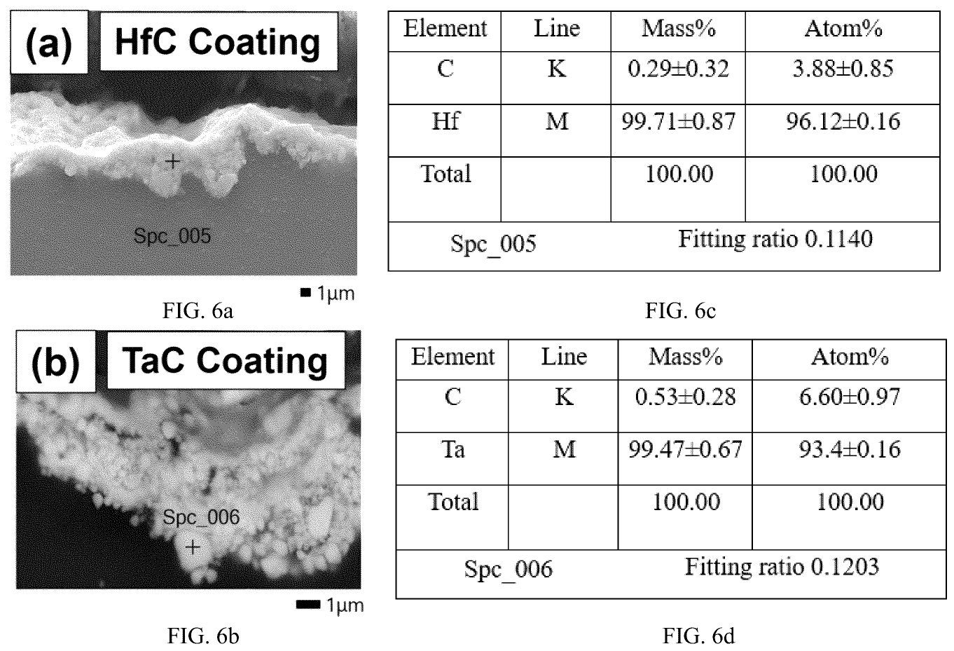

A coating of TaC was formed on an Al 6061 substrate using the method illustrated in FIG. 2. FIG. 1a shows an image of the TaC powder, and FIGS. 3a-3d show images of the TaC coating on the Al 6061 substrate. FIG. 6b shows an energy dispersive spectroscopy (EDS) scan of a cross section of the TaC coating, and FIG. 6d shows a table with results of the EDS scan. FIG. 7a shows the X-ray diffraction (XRD) response of the TaC coating on the Al 6061 substrate.

### Example 2

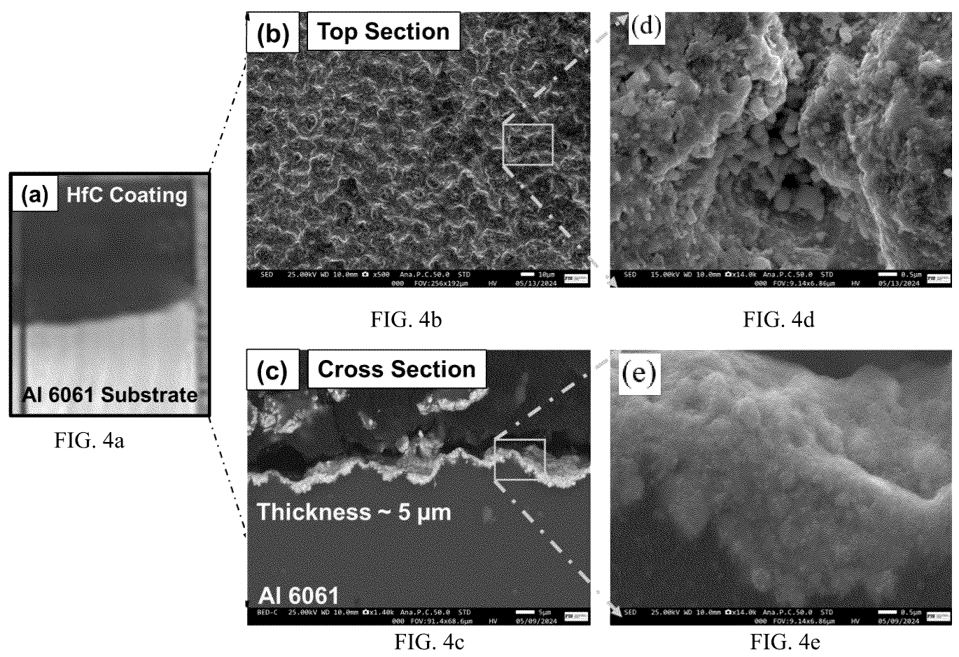

A coating of HfC was formed on an Al 6061 substrate using the method illustrated in FIG. 2. FIG. 1b shows an image of the HfC powder, and FIGS. 4a-4d show images of the HfC coating on the Al 6061 substrate. FIG. 6a shows an EDS scan of a cross section of the HfC coating, and FIG. 6c shows a table with results of the EDS scan. FIG. 7b shows the XRD response of the HfC coating on the Al 6061 substrate. FIGS. 8a-8c show atomic force microscopy (AFM) results for the HfC coating, including the nanoscale mechanical response values.

### Example 3

A coating of TaC with 4 weight percent (wt. %) of CNTs (“TaC-4 CNT”) was formed on an Al 6061 substrate using the method illustrated in FIG. 2. FIGS. 1c and 1d show images of the TaC-4 CNT powder, and FIGS. 5a-5d show images of the TaC-4 CNT coating on the Al 6061 substrate. FIG. 6b shows an EDS scan of a cross section of the TaC coating, and FIG. 6d shows a table with results of the EDS scan. FIG. 7a shows the XRD response of the TaC coating on the Al 6061 substrate. FIGS. 9a-9c show coating build-up mechanisms in the TaC-4 CNT coating.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

What is claimed is:

1. A method for depositing a coating that comprises an ultra-high-temperature ceramic (UHTC), the method comprising:
preparing a powder comprising the UHTC, the powder having a powder size distribution (PSD) of 10 micrometers (μm) or less;
performing a cold spray deposition, using the powder as a feed material, to deposit the coating on a first surface of a substrate,
the first surface of the substrate having a surface roughness of at least 1 μm,
the cold spray deposition being performed at a temperature of no more than 800° C., and
a thickness of the coating being in a range of from 100 nanometers (nm) to 100 μm.

2. The method according to claim 1, further comprising:
before performing the cold spray deposition, mixing the UHTC with nanomaterials, such that the powder used as the feed material for the cold spray deposition comprises agglomerates of the UHTC and the nanomaterials.

3. The method according to claim 2, the nanomaterials comprising at least one of carbon nanotubes (CNTs) and boron nitride nanotubes (BNNTs).

4. The method according to claim 1, the PSD of the powder being about 5 μm or less.

5. The method according to claim 1, the thickness of the coating being in a range of from about 2 μm to 5 μm.

6. The method according to claim 1, the surface roughness of the first surface of the substrate being at least 1.7 μm.

7. The method according to claim 1, the UHTC being tantalum carbide (TaC) or hafnium carbide (HfC).

8. The method according to claim 1, the cold spray deposition being performed at a temperature of no more than 550° C.

9. The method according to claim 1, the preparing of the powder comprising ball milling or cryomilling the UHTC to obtain the PSD of 10 μm or less.

10. The method according to claim 9, the preparing of the powder further comprising performing spray drying after the ball milling or cryomilling.

11. The method according to claim 1, the cold spray deposition being performed while a distance between the first surface of the substrate and a nozzle of a cold spray deposition system performing the cold spray deposition is in a range of from 1 millimeter (mm) to 10 mm.

12. The method according to claim 11, the cold spray deposition being performed while the distance between the first surface of the substrate and the nozzle is about 5 mm.

13. The method according to claim 1, the cold spray deposition being performed at a pressure in a range of from 50 pounds per square inch (psi) to 300 psi.

14. The method according to claim 1, the cold spray deposition being performed at a pressure of about 100 psi.

15. A composition, comprising:
a substrate having a first surface;
a coating disposed on the first surface of the substrate and comprising an ultra-high-temperature ceramic (UHTC),
the first surface of the substrate having a surface roughness of at least 1 μm, and
a thickness of the coating being in a range of from 100 nanometers (nm) to 100 μm.

16. The composition according to claim 1, the coating further comprising nanomaterials, and
the nanomaterials comprising at least one of carbon nanotubes (CNTs) and boron nitride nanotubes (BNNTs).

17. The composition according to claim 1, the thickness of the coating being in a range of from about 2 μm to 5 μm, and
the surface roughness of the first surface of the substrate being at least 1.7 μm.

18. The composition according to claim 1, the UHTC being tantalum carbide (TaC) or hafnium carbide (HfC).

19. The composition according to claim 1, the substrate comprising at least one of a metal, a ceramic, and a polymer.

20. A method for depositing a coating that comprises an ultra-high-temperature ceramic (UHTC), the method comprising:
preparing a powder comprising the UHTC, the powder having a powder size distribution (PSD) of about 5 micrometers (μm) or less;
performing a cold spray deposition, using the powder as a feed material, to deposit the coating on a first surface of a substrate,
the first surface of the substrate having a surface roughness of at least 1.7 μm,
the cold spray deposition being performed at a temperature of no more than 500° C., and
a thickness of the coating being in a range of from about 2 μm to 5 μm,
the method further comprising, before performing the cold spray deposition, mixing the UHTC with nanomaterials, such that the powder used as the feed material for the cold spray deposition comprises agglomerates of the UHTC and the nanomaterials,
the nanomaterials comprising at least one of carbon nanotubes (CNTs) and boron nitride nanotubes (BNNTs),
the UHTC being tantalum carbide (TaC) or hafnium carbide (HfC),
the preparing of the powder comprising ball milling or cryomilling the UHTC to obtain the PSD of 5 μm or less, followed by spray drying,
the cold spray deposition being performed while a distance between the first surface of the substrate and a nozzle of a cold spray deposition system performing the cold spray deposition is in a range of from 1 millimeter (mm) to 10 mm, and
the cold spray deposition being performed at a pressure of no more than 300 pounds per square inch (psi).
